(19) United States
(12) Patent Application Publication
(10) Pub. No.: US 2025/0265709 A1
(43) Pub. Date: Aug. 21, 2025

(54) SYSTEM FOR PANCREATIC CANCER IMAGE SEGMENTATION BASED ON MULTI-VIEW FEATURE FUSION NETWORK

(71) Applicant: SHANDONG NORMAL UNIVERSITY, Jinan (CN)

(72) Inventors: Jie XUE, Jinan (CN); Qi LI, Jinan (CN); Dengwang LI, Jinan (CN); Guanzhong GONG, Jinan (CN); Xiangfei CHAI, Jinan (CN); Pu HUANG, Jinan (CN); Shulei CHANG, Jinan (CN)

(21) Appl. No.: 19/011,881

(22) Filed: Jan. 7, 2025

(30) Foreign Application Priority Data
Feb. 21, 2024 (CN) 2024101932721

(51) Int. Cl. G06T 7/00; G06T 7/174

(52) U.S. Cl. CPC G06T 7/0012; G06T 7/174; G06T 2207/10081; G06T 2207/20041; G06T 2207/20084; G06T 2207/30024

(57) ABSTRACT

A system for pancreatic cancer image segmentation based on a multi-view feature fusion network, comprising inputting acquired computed tomography (CT) image into network model, extracting shallow features of CT image to obtain shallow feature map; reconstructing the shallow feature map into code sequence and inputting into lightweight Transformer for extracting global dependency relationship; carrying out operations on the shallow feature map to obtain first feature map; fusing the global dependency relationship and the first feature map to obtain second feature map; discarding redundant information from feature map obtained through convolution operation of each layer of the network, and regarding top-level feature map with discarded redundant information as third feature map; and carrying out pooling operations on the third feature map to obtain predicted boundary circle of target region, adding regularization item to the predicted boundary circle to obtain reference boundary circle, then outputting result.

### CROSS-REFERENCE TO RELATED APPLICATIONS

The present disclosure claims priority to Chinese Patent Application No 202410193272.1, entitled “System for Pancreatic Cancer Image Segmentation Based on Multi-view Feature Fusion Network”, filed on Feb. 21, 2024, with the China National Intellectual Property Administration (CNIPA), the entire contents of which are incorporated herein by reference.

### TECHNICAL FIELD

The present disclosure belongs to the technical field of medical image processing, and specifically relates to a system for pancreatic cancer image segmentation based on a multi-view feature fusion network.

### BACKGROUND

Statements in this part merely provide information of background art related to the present disclosure, and do not certainly constitute the prior art.

Pancreatic cancer is one of common, fatal and invasive malignant tumors, resulting in a 5-year survival rate of less than 7%. Surgery and radiotherapy are common methods for treating the pancreatic cancer. A pancreas and a tumor are generally required to be precisely positioned during treatment. The pancreas and the tumor are generally segmented manually by a radiologist. Relying on doctor's expertise, this method is time-consuming and error-prone. Since automatic segmentation of a pancreas and a tumor in the prior art has the following problems, a segmentation result is unsatisfactory: (1) complex anatomical structures: shapes, sizes and positions of pancreases and tumors of different patients are different; (2) low contrasts: contrasts between a pancreas and other surrounding abdominal tissue, and between the pancreas and an embedded tumor are extremely low; and (3) small voxel proportions: an average proportion of a pancreas in an abdomen is about 0.6%, and an average proportion of a tumor is about 0.2%.

To solve the above problems, plenty of researchers use convolutional neural networks (CNNs) to segment pancreatic cancer images. However, for small target regions (such as pancreas and tumor regions) having complex anatomical structures and unclear boundaries, existing methods for pancreatic cancer segmentation by using convolutional neural networks focus on static learning of boundaries. Thus, models may be easily misled by voxels similar to the boundaries, segmentation is insufficient, and segmentation accuracy is reduced. Then, most convolutional neural networks do not follow morphological features of objects, and mainly focus on learning of useful features corresponding to labels, thereby ignoring reduction of redundant information from input images, and further causing noise in feature mapping. In addition, although methods based on convolutional neural networks have outstanding feature extraction capabilities, the methods are not adept at modeling remote dependency due to limited acceptance domains of convolution kernels. As a result, the convolutional neural networks cannot fully learn global semantic information of images.

### SUMMARY

To solve the above problems, the present disclosure provides a system for pancreatic cancer image segmentation based on a multi-view feature fusion network. The system includes an adaptive morphological feature fusion module, a bidirectional semantic feature fusion module, and a local-global dependency feature fusion module. The system is used for joint segmentation of a pancreas and a tumor in a computed tomography (CT) image to improve segmentation accuracy of a complex phenotype target region.

To achieve the above objective, the present disclosure mainly includes the following aspects.

In a first aspect, the present disclosure provides a system for pancreatic cancer image segmentation based on a multi-view feature fusion network. The system includes:
a CT device, being configured to acquire a three-dimensional (3D) CT image to be segmented of a specific region of an abdomen of a patient to be detected for a pancreatic cancer detection, and input the 3D CT image to be segmented into a computer; and
the computer, being configured to:
input the 3D CT image to be segmented into a trained multi-view feature fusion network model, extract a shallow feature of the 3D CT image to be segmented through a convolution operation, obtain a shallow feature map, split the shallow feature map, add positional encoding, reconstruct the shallow feature map into a code sequence, input the code sequence into a lightweight Transformer, and extract a global dependency relationship of the shallow feature; and carry out a plurality of operations on the shallow feature map, obtain a first feature map, fuse the global dependency relationship and the first feature map, and obtain a second feature map;
discard redundant information from a feature map obtained through a convolution operation of each layer of the network, and regard a top-level feature map of which redundant information is discarded as a third feature map;
carry out pooling operations (morphological dilation and erosion operations) on the third feature map, obtain a predicted boundary circle of a target region, add a regularization item to the predicted boundary circle, and obtain a reference boundary circle; and output a tumor segmentation result of the 3D CT image to be segmented;
wherein, determining at least one feature of a tumor to the pancreatic cancer detection of the patient to be detected by analyzing the output tumor segmentation result of the 3D CT image to be segmented.

Preferably, the redundant information is discarded from the feature map obtained through the convolution operation of each layer of the network specifically as follows:
a feature is extracted by a Gram matrix from the feature map obtained through the convolution operation of each layer of the network, a corresponding attention feature map is generated, and the feature map obtained through the convolution operation of each layer is connected to the corresponding attention feature map.

Preferably, the redundant information is generated by inversely quantizing mutual information between an input feature map and a generated attention feature map.

Preferably, a convolution kernel size of the pooling operation is affected by a learning performance of the network. When an average performance of morphological learning of the target region evaluated by using a Dice similarity coefficient is improved to a set level, the adaptive morphological feature fusion module narrows a boundary circle.

Preferably, the convolution kernel size of the pooling operation is an odd number. The kernel size is linearly reduced as a model performance is improved.

Preferably, the regularization item is added to the predicted boundary circle, and the reference boundary circle is obtained specifically as follows:

a representation of a boundary circle is obtained through the morphological dilation and erosion operations, and context information around a target boundary is captured.

Preferably, the at least one feature included in the tumor includes but is not limited to a tumor region, a tumor size, and a tumor and tissue boundary position.

Preferably, the system for pancreatic cancer image segmentation based on a multi-view feature fusion network further includes a preprocessing module configured to preprocess the 3D CT image to be segmented specifically as follows:
rotation, scaling, elastic deformation, gamma correction, mirroring, and brightness adjustment operations are carried out on the 3D CT image to be segmented, the 3D CT image to be segmented is clipped into an image having a fixed size, and the image is manually labeled.

Preferably, validity of the multi-view feature fusion network is validated through five-fold cross-validation.

Evaluation indexes are a Dice similarity coefficient, an average surface distance, a positive predictive value, and sensitivity.

In a second aspect, the present disclosure provides a medium. The medium stores a program. When the program is executed by a processor, the following steps are implemented:
acquiring a 3D CT image to be segmented;
inputting the 3D CT image to be segmented into a trained multi-view feature fusion network model, extracting a shallow feature of the 3D CT image to be segmented through a convolution operation, obtaining a shallow feature map, splitting the shallow feature map, adding positional encoding, reconstructing the shallow feature map into a code sequence, inputting the code sequence into a lightweight Transformer, and extracting a global dependency relationship of the shallow feature; and carrying out a plurality of operations on the shallow feature map, obtaining a first feature map, fusing the global dependency relationship and the first feature map, and obtaining a second feature map;
discarding redundant information from a feature map obtained through a convolution operation of each layer of a network, and regarding a top-level feature map of which redundant information is discarded as a third feature map; and
carrying out pooling operations (morphological dilation and erosion operations) on the third feature map, obtaining a predicted boundary circle of a target region, adding a regularization item to the predicted boundary circle, obtaining a reference boundary circle, and outputting a tumor segmentation result of the 3D CT image to be segmented;
wherein, determining at least one feature of a tumor to the pancreatic cancer detection of the patient to be detected by analyzing the output tumor segmentation result of the 3D CT image to be segmented.

In a third aspect, the present disclosure provides an electronic device. The electronic device includes a memory, a processor, and a program stored in the memory and operable on the processor. When the processor executes the program, the following steps are implemented:
acquiring a 3D CT image to be segmented;
inputting the 3D CT image to be segmented into a trained multi-view feature fusion network model, extracting a shallow feature of the 3D CT image through a convolution operation, obtaining a shallow feature map, splitting the shallow feature map, adding positional encoding, reconstructing the shallow feature map into a code sequence, inputting the code sequence into a lightweight Transformer, and extracting a global dependency relationship of the shallow feature; and carrying out a plurality of operations on the shallow feature map, obtaining a first feature map, fusing the global dependency relationship and the first feature map, and obtaining a second feature map;
discarding redundant information from a feature map obtained through a convolution operation of each layer of a network, and regarding a top-level feature map of which redundant information is discarded as a third feature map; and
carrying out pooling operations (morphological dilation and erosion operations) on the third feature map, obtaining a predicted boundary circle of a target region, adding a regularization item to the predicted boundary circle, obtaining a reference boundary circle, and outputting a tumor segmentation result of the 3D CT image to be segmented;
wherein, determining at least one feature of a tumor to the pancreatic cancer detection of the patient to be detected by analyzing the output tumor segmentation result of the 3D CT image to be segmented.

Compared with the prior art, the present disclosure has beneficial effects as follows:

The present disclosure provides a system for pancreatic cancer image segmentation based on a multi-view feature fusion network. The system has three feature fusion modules, that is, an adaptive morphological feature fusion module (AMF2), a bidirectional semantic feature fusion module (BSF2), and a local-global dependency feature fusion module (LGDF2). The system is used for joint segmentation of a pancreas and a tumor in a CT image. The adaptive morphological feature fusion module (AMF2) can dynamically learn and fuse morphological features from a skeleton to a boundary, and fuse the morphological features and discriminative spatial semantic context information to further improve a segmentation performance on a target region having a complex phenotype. The bidirectional semantic feature fusion module (BSF2) is used to constrain mutual information between a prediction and a label, and discard redundant information between input and a prominent attention feature to improve a capacity of recognizing a pancreas and a tumor. The local-global dependency feature fusion module (LGDF2) fuses a self-attention mechanism and a convolutional neural network, and models a global-local dependency relationship. Shallow features are fused by using a lightweight Transformer and the convolutional neural network, the global-local dependency relationship is modeled, and global information provided by the shallow features missing in a current network framework is supplemented. The method solves the problems of insufficient segmentation and low precision of a method for pancreas and tumor segmentation in the prior art, and improves segmentation accuracy of target regions having complex phenotypes.

### BRIEF DESCRIPTION OF THE DRAWINGS

Accompanying drawings of the description serve as a constituent part of the present disclosure to provide a further understanding of the present disclosure. Embodiments of the present disclosure and their descriptions serve to explain the present disclosure, and are not to be construed as unduly limiting the present disclosure.

FIG. 1 is a flow diagram of data processing of a system for pancreatic cancer image segmentation based on a multi-view feature fusion network according to the present disclosure;

FIG. 2 is a general framework diagram of a multi-view feature fusion network according to the present disclosure;

FIG. 3 is a network framework diagram of an adaptive morphological feature fusion module according to the present disclosure;

FIG. 4 is an example of a representation of a dynamic boundary circle according to the present disclosure;

FIG. 5 is a network framework diagram of a bidirectional semantic feature fusion module according to the present disclosure;

FIG. 6 is a network framework diagram of a local-global dependency feature fusion module according to the present disclosure;

FIG. 7 is an exemplary diagram of segmentation of a pancreas and a tumor on a medical segmentation decathlon (MSD) dataset according to the present disclosure; and

FIG. 8 is an exemplary diagram of segmentation of a liver and a tumor on a liver tumor segmentation (LiTS) benchmark according to the present disclosure.

### DETAILED DESCRIPTION

The present disclosure will be further described below in combination with accompanying drawings and examples.

It should be pointed out that the following detailed descriptions are illustrative and are intended to provide further descriptions of the present disclosure. All technical and scientific terms used herein have the same meanings as commonly understood by those of ordinary skill in the art to which the present disclosure belongs unless otherwise indicated.

It should be noted that terms used herein are merely for describing particular implementations and are not intended to limit illustrative implementations of the present disclosure. As used herein, singular is also intended to include plural unless the context clearly points out singular or plural. In addition, it should be understood that terms “include” and/or “including” used in the description indicate the presence of features, steps, operations, devices, assemblies and/or their combinations.

In the present disclosure, orientation or position relationships indicated by terms such as “upper”, “lower”, “left”, “right”, “front”, “rear”, “vertical”, “horizontal”, “side”, and “bottom” are based on those shown in the accompanying drawings, are merely relational terms determined for conveniently describing structural relationships of various components or elements in the present disclosure, do not specifically refer to any component or element in the present disclosure, and should not be construed as a limitation on the present disclosure.

In the present disclosure, terms such as “fixedly connect”, “connected”, and “connecting” should be understood in a broad sense. For instance, they can denote a fixed connection, an integrated connection, or a detachable connection, or denote a direct connection denote, or an indirect connection via an intermediate medium. The specific meanings of the above terms in the present disclosure can be determined by relevant scientific or technical personnel in the art according to specific circumstances, and should not be construed as limiting the present disclosure.

According to the present disclosure, model training, testing, and evaluation are achieved based on a hardware environment of a NVIDIA Tesla P100 graphics processing unit (GPU) of 16 GB of an open source PyTorch framework. In a training phase, no pretrained model is used. An initial learning rate of a network is set as 0.01, and a model fitting parameter is found in an exponential damping manner. A Dropout parameter is set as 0.1 to avoid over-fitting, and a Batchsize is set as 2. A model is optimized by iteratively updating parameters such as a convolution kernel weight by a stochastic gradient descent (SGD) optimizer.

### Example 1

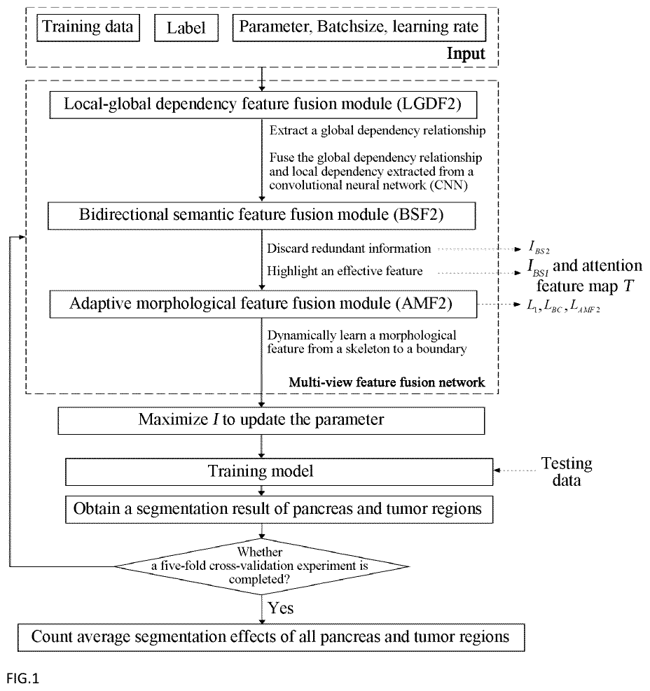

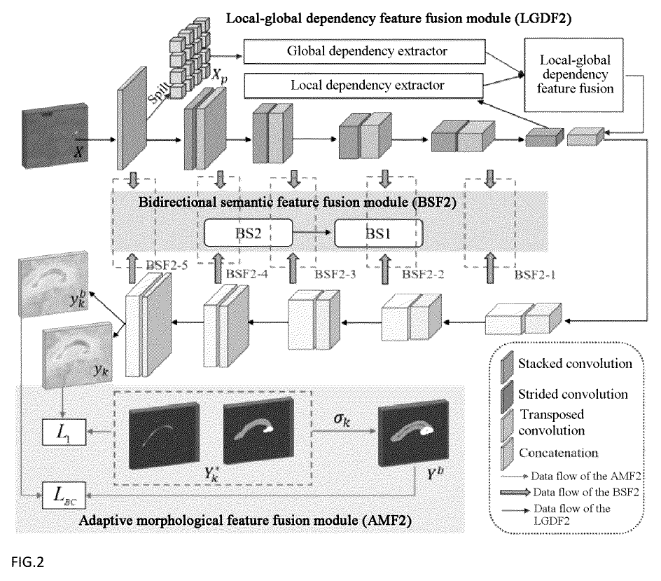

As shown in FIG. 1 and FIG. 2, the present disclosure provides a system for pancreatic cancer image segmentation based on a multi-view feature fusion network. The system includes:
a CT device configured to acquire a CT image of a specific region of an abdomen of a patient to be detected for a pancreatic cancer detection, acquire a 3D CT image to be segmented, and input the 3D CT image to be segmented into a computer.

The computer is first required to preprocess the 3D CT image to be segmented specifically as follows:
all data are enhanced through rotation, scaling, elastic deformation, gamma correction, mirroring, and brightness adjustment, and the 3D pancreatic CT image of which unnecessary background is deleted is clipped into an image having a fixed size of 64×192×192. According to the present disclosure, 281 cases in a medical segmentation decathlon (MSD) pancreas dataset are randomly divided into a training set and a testing set according to a ratio of 4:1. A performance of a proposed model is verified through a five-fold cross-validation experiment. In each fold of experiment, four-fold data and corresponding labels are used in the training phase, and the remaining data is used to automatically generate a segmentation result in the testing phase.

The preprocessed 3D CT image to be segmented is input into the trained multi-view feature fusion network model.

Table 1 shows a network structure of a model. Specifically, “In” represents an input channel, and “Out” represents an output channel. Moreover, “[3×3×3, 32]” represents a stacked convolutional layer having a size of 3×3×3 and an output channel of 32, “[ ]×2” represents that a block is a plurality of twice, and “[3×3×3, 32], stride 2×2×2” represents a Stride convolutional layer having a size of 3×3×3 and a stride of 2×2×2.

TABLE 1
Network structure of multi-view feature fusion network (MF2N)

| Layer | Composition | Output |
|---|---|---|
| Stacked Conv 1 | [3 × 3 × 3, 32] × 2 | [64, 192, 192] |
| Stride Conv 1 | [3 × 3 × 3, 64], stride 2 × 2 × 2 | [32, 96, 96] |
| Stacked Conv 2 | [3 × 3 × 3, 64] | [32, 96, 96] |
| Stride Conv 2 | [3 × 3 × 3, 128], stride 2 × 2 × 2 | [16, 48, 48] |
| Stacked Conv 3 | [3 × 3 × 3, 128] | [16, 48, 48] |
| Stride Conv 3 | [3 × 3 × 3, 256], stride 2 × 2 × 2 | [8, 24, 24] |
| Stacked Conv 4 | [3 × 3 × 3, 256] | [8, 24, 24] |
| Stride Conv 4 | [3 × 3 × 3, 320], stride 2 × 2 × 2 | [4, 12, 12] |
| Stacked Conv 5 | [3 × 3 × 3, 320] | [4, 12, 12] |
| Stride Conv 5 | [3 × 3 × 3, 320], stride 1 × 2 × 2 | [4, 6, 6] |
| Stacked Conv 6 | [3 × 3 × 3, 320] | [4, 6, 6] |
| LGDF2 | In:32, Out:320 | [4, 6, 6] |
| Transposed Conv 1 | [1 × 2 × 2, 320] | [4, 12, 12] |
| BSF2 1 | In:320, Out:320 | [4, 12, 12] |
| Stacked Conv 7 | [3 × 3 × 3, 320] × 2 | [4, 12, 12] |
| Transposed Conv 2 | [2 × 2 × 2, 256] | [8, 24, 24] |
| BSF2 2 | In:256, Out:256 | [8, 24, 24] |
| Stacked Conv 8 | [3 × 3 × 3, 128] × 2 | [8, 24, 24] |
| Transposed Conv 3 | [2 × 2 × 2, 128] | [16, 48, 48] |
| BSF2 3 | In:128, Out:128 | [16, 48, 48] |
| Stacked Conv 9 | [3 × 3 × 3, 64] × 2 | [16, 48, 48] |
| Transposed Conv 4 | [2 × 2 × 2, 64] | [32, 96, 96] |
| BSF2 4 | In:64, Out:64 | [32, 96, 96] |
| Stacked Conv 10 | [3 × 3 × 3, 32] × 2 | [32, 96, 96] |
| Transposed Conv 5 | [2 × 2 × 2, 32] | [64, 192, 192] |
| BSF2 5 | In:32, Out:32 | [64, 192, 192] |
| Stacked Conv 11 | [3 × 3 × 3, 32] × 2 | [64, 192, 192] |
| Final Conv | [1 × 1 × 1, 32] | [64, 192, 192] |

For organs/tumors having large inter-patient differences in shape, size, and texture, local and global context features are critical in capturing overall phenotypic features and further obtaining a favorable segmentation performance. A method based on a convolutional neural network is mainly adept at extracting local features. Due to an inherent locality of convolution computation, the method faces a challenge in extracting the global context features and a long-term dependency relationship of a target region. The Transformer gains an advanced performance of exploring global context information. However, in 3D convolutional neural networks embedded in most Transformers, due to large memory consumption of Transformer modules, the models cannot extract more pixel information and some fine-grained information in shallow layers, such as some texture and boundary information, resulting in unsatisfactory segmentation results. To solve the above problems, according to the present disclosure, a local-global dependency feature fusion module (LGDF2) is designed based on a Transformer such that global semantic information extracted by the lightweight Transformer can be supplemented into the convolutional neural network, and local features and global information provided by shallow features can be fused.

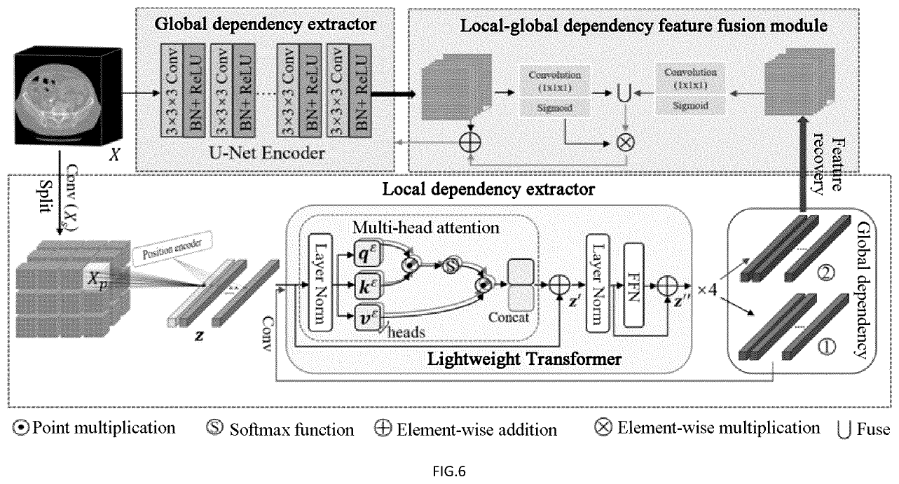

As shown in FIG. 6, original 3D CT image block X is given. A shallow feature is first extracted by using convolutional layers. An obtained feature map is split into non-overlapping sample blocks Xₚ (Equation 1) each having a size of 4×4×4. The features are reconstructed into sequence embedding zₚ (Equation 2) by adding learnable positional encoding eₚ^{pos}. Finally, zₚ is input into the lightweight Transformer (Equation 3 to Equation 6), high-resolution global information between sample blocks is explored to the utmost extent. A global dependency relationship of the shallow feature is extracted.

$$X \to {X}_{s} \to {\sum }_{p = 1}^{\frac{W \times H \times D}{{4}^{3}}} {X}_{p} = {\sum }_{p = 1}^{\frac{W \times H \times D}{{4}^{3}}} {X}_{0} + 4 ( p - 1 ) \qquad ( 1 )$$

Specifically, → shows a movement direction, Xₛ represents a convoluted shallow feature, X₀ represents a starting position of the non-overlapping sample blocks, number 4 is used to describe a position of each non-overlapping sample block relative to the starting position, p^{th} non-overlapping sample block Xₚ can be represented as X₀+4 (p−1), and p represents an index of non-overlapping sample blocks, ranging from 0 to

$$\frac{W \times H \times D}{{4}^{3}} .$$

$${z}_{p} = {g}_{p} + {e}_{p}^{p o s} \qquad ( 2 )$$

Sequence z=z₁, z₂, . . . , zₙ is input of the lightweight Transformer, zₚ refers to a p^{th} code sequence with positional encoding, gₚ represents that a compressed vector is obtained from the feature map, and eₚ^{pos} represents a learnable position code.

The lightweight Transformer (Equation 3 to Equation 6) computes global dependency relationships z′ and z″ in the network. Firstly, input sequence representation z after layer normalization is multiplied by matrices W_{Q}^{E}, W_{K}^{E}, and W_{V}^{ε} respectively, and query vector q^{ε}, key vector k^{ε}, and value vector v^{ε} are obtained.

$$( {q}^{ε} / {k}^{ε} / {v}^{ε} ) = {W}_{Q}^{ε} / {W}_{K}^{ε} / {W}_{V}^{ε} L a y e r N o r m ( z ) ∈ {ℝ}^{{C}_{h}} \qquad ( 3 )$$

Specifically, ¿ represents an index of a plurality of attention heads, Cₕ=C/ε is a dimension of each self-attention head, C is a current channel, and LayerNorm(⋅) is a layer normalization function.

Then, intermediate representations z′ and z″ of the global dependency relationship of the network are computed by using Equation 4 and Equation 5. Moreover, z′ is obtained by summing linear projections of z and a fully connected layer (FC) onto a matrix vector of all attention heads. In addition, to enhance a representation of a current feature, an effective expression is highlighted by using a feed forward neural network (FFN) layer. As shown in Equation 6, the feed forward neural network layer is represented as a two-layer fully connected layer and maps data to a high-dimensional space and then to a low-dimensional space to learn more abstract features and enhance an expression capability of the network.

$${z}^{′} = FC ( {\sum }_{1}^{4} Softmax ( \frac{{q}^{a}}{\sqrt{{C}_{h}}} \cdot {k}^{a} ) {v}^{a} + z \qquad ( 4 )$$

$${z}^{″} = FFN ( L a y e r N o r m ( {z}^{′} ) ) + {z}^{′} \qquad ( 5 )$$

$$FFN ( x ) = {σ}_{R} ( 0 , {xW}_{1} + {b}_{1} ) {W}_{2} + {b}_{2} \qquad ( 6 )$$

Specifically, Softmax(⋅) is a Softmax function, LayerNorm(⋅) is the layer normalization function, data is moved to an active region of an activation function such that the activation function can works better, W₁, W₂, b₁, and b₂ are learnable parameters in the feed forward neural network, and OR represents a computation form of an ReLU activation function.

Then, features extracted from z″ are re-input into the lightweight Transformer, and a global dependency relationship between different channels is extracted. Finally, elastic information fusion of global features and local features extracted by the convolutional neural network is achieved through exclusive OR, multiplication, and addition operations, and learnable information of the network is further supplemented.

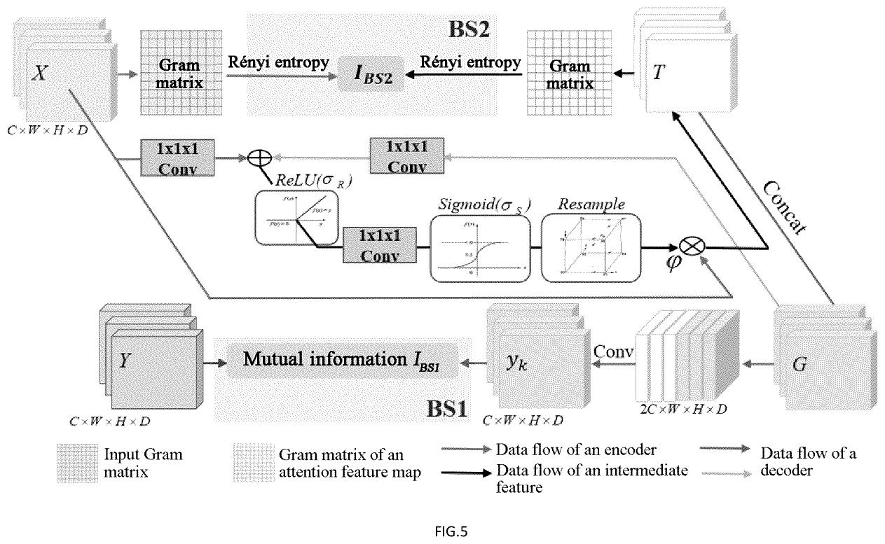

Most deep learning models focus on extracting valid features of organs/tumors, maximizes similarity between output and a label, and ignores elimination of duplication and redundant information from input. As a result, the network extracts irrelevant features from insignificant tissue (such as background and target surrounding organs) of the input during training. In a pancreas and tumor specific segmentation task, corresponding features of regions where a pancreas and a tumor are located are regarded as valid information, and corresponding features of non-overlapping regions of the pancreas and the tumor are regarded as redundant information. Accordingly, inspired by mutual information learning at an information bottleneck, a bidirectional semantic feature fusion module (BSF2) (FIG. 5) is proposed in the present disclosure. By the bidirectional semantic feature fusion module, not only mutual information (BS1) between network output and a label is constrained, but also redundant information (BS2) obtained by inversely quantizing mutual information between input and a generated attention feature map is discarded.

As shown in FIG. 5, feature map X is given, BSF2 generates attention feature map T, and an decoder branch outputs feature map T′ after connecting T and feature map G. The goal is to compress information irrelevant to the target region in input X as much as possible, obtain representation T to constrain input information, ensure feature map T′ including representation T to be consistent with label Y, and retain information about label Y in input X.

Specifically, the BSF2 can be expressed as:

$$I = max ( {I}_{BS 1} - {I}_{B S 2} ) \qquad ( 7 )$$

Specifically, I represents information learned by the BSF2; I_{BS1} represents mutual information between a prediction and an artificial label, measures a segmentation performance of the network, and is expressed as L_{AMF2} in the network; I_{BS2} is redundant information to be discarded between input X and generated attention feature map T, and measures redundancy of information; and β∈[0,1] is an introduced fixed parameter to control a compression ratio.

$${I}_{B S 2} = {H}_{α} ( X ) + {H}_{α} ( T ) - {H}_{α} ( X ⊙ T ) \qquad ( 8 )$$

Specifically, X is an input feature map, T is an attention feature map generated by an effective feature extraction gating, and X⊙T represents an Hadamard product between X and T.

$$T = φ X = [ {σ}_{S} ( w {σ}_{R} ( {w}_{x} X + {w}_{g} G ) ) ] X \qquad ( 9 )$$

Specifically, as shown in FIG. 5, G is a feature map after operations by a decoder branch on a Transposed convolutional layer and a Stacked convolutional layer, wₓ, w_{g}, and w are trainable parameters in three 1×1×1 convolutional layers respectively, OR represents the ReLU activation function, σ_{S} represents a Sigmoid activation function, and φ is a normalization matrix obtained by the Sigmoid activation function.

In a high-dimensional space, mutual information is difficult to compute because of high computational cost. Since a order entropy functional of matrix-based Rényi can directly compute mutual information in a convolution process without an additional variational approximation and distribution estimation in a variational inference method, the a order entropy functional (Equation 10) of the matrix-based Rényi is used to compute the mutual information. To make full use of existing features, a Gram matrix (shown in FIG. 5) is used to extract hidden information between features of different dimensions while preserving existing original information.

$${H}_{α} ( x ) = \frac{1}{1 - α} {log}_{2} ( {\sum }_{i = 1}^{s} {χ}_{i}^{α} ( \frac{K ( x )}{t r ( K ( x ) )} ) ) \qquad ( 10 )$$

Specifically, α is a fixed α-order parameter, K(x)/tr(K(x)) is a normalization operation, K(x)=exp(−γ∥x∥²) is a Gram matrix of features obtained from a radial basis function (RBF), χᵢ represents an i^{th} eigenvalue of transformation, s is a number of eigenvalues, and γ is a random bias introduced in convolutional neural network training.

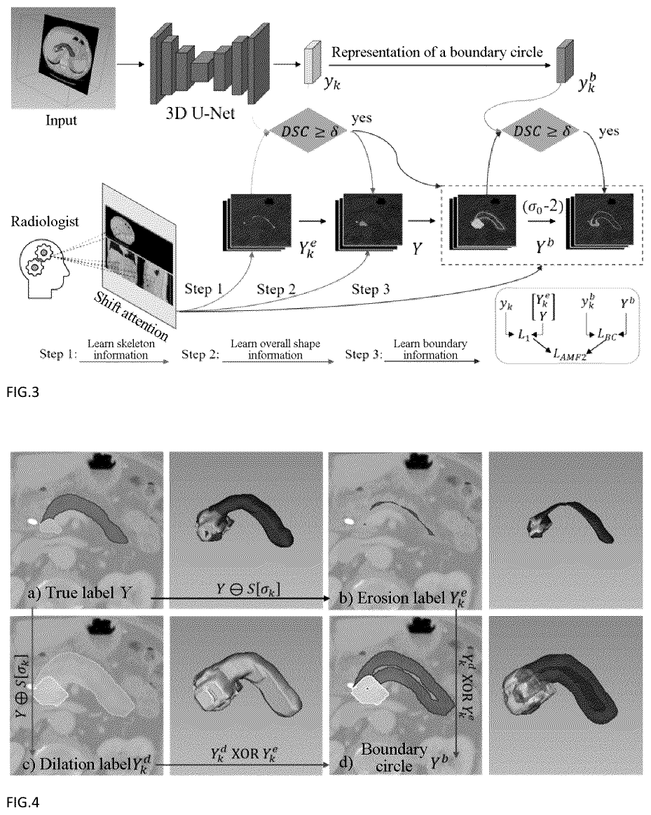

Due to an irregular shape and an unclear boundary of a pancreatic region, similar intensity of a tumor and surrounding tissue is one of the main challenges of such a specific segmentation task. In clinical practice, radiologists generally focus on an overall morphological trend of a pancreas first, and then shift their attention to the entire pancreas and tumor to avoid under-segmentation. Moreover, the radiologists will further pay close attention to features around a boundary to ensure that the boundary of the target region is correctly delineated. According to the above clinical experience, as shown in FIG. 3, the adaptive morphological feature fusion module (AMF2) is proposed in the present disclosure. Morphological information of a pancreas and a tumor at different attention levels is fused to help the network in obtaining accurate segmentation.

Specifically, in an early stage of training, the AMF2 obtains a skeleton of the target region through a pooling operation, and provides a reliable dynamic label for the network according to a current learning state of the network to grasp a morphological trend of target learning. During training, as shown in Equation 12, when a Dice similarity coefficient (DSC) of the pancreas and the tumor reaches an average value of the MF2N without the AMF2, the AMF2 starts to shift attention to the entire pancreas and tumor. The above process can mitigate an under-segmentation problem, and is overseen and implemented by using cross-entropy loss and a soft Dice loss function (Equation 11).

$${L}_{1} = - \frac{1}{N} {\sum }_{n = 0}^{N - 1} [ {Y}_{k}^{*} ln {y}_{k} + ( 1 - {Y}_{k}^{*} ) ln ( 1 - {y}_{k} ) ] - \frac{2 {\sum }_{{n}_{t}} {Y}_{k}^{*} {y}_{k}}{{\sum }_{{n}_{t}} ( {Y}_{k}^{*} + {y}_{k} )} \qquad ( 11 )$$

$${Y}_{k}^{*} = \{ \begin{matrix}Y , if \frac{2 \vert {y}_{k} ⋂ {Y}_{k}^{e} \vert}{\vert {y}_{k} \vert + \vert {Y}_{k}^{e} \vert} \geq δ \\ {Y}_{k}^{e} , if \frac{2 \vert {y}_{k} ⋂ {Y}_{k}^{e} \vert}{\vert {y}_{k} \vert + \vert {Y}_{k}^{e} \vert} < δ\end{matrix} \qquad ( 12 )$$

Specifically, Y represents an original label, Yₖ* represents a dynamic label, yₖ is a prediction result of the network at a k^{th} epoch, Yₖ^{e}=Y⊖S[σₖ] represents a skeleton label at the k^{th} epoch obtained by implementing morphological erosion operation ⊖ on Y through a max pooling operation, σₖ is a convolution kernel size of the max pooling operation, S[σₖ] is a morphological structure element, δ∈[0,1] is a fixed parameter equal to an average DSC value of the pancreas and the tumor obtained from a model without the AMF2, and N and nₜ represent a number of samples and a number of voxels of the target regions (that is, pancreas and tumor regions) respectively.

When the network tends to learn features of the entire pancreas and tumor, the AMF2 module focuses on a representation around a boundary by adding regularization item L_{BC} (Equation 13) to cause the network to extract more boundary information, and further assists the network in identifying a target boundary. It can be seen from an example of a representation of a dynamic boundary circle shown in FIG. 4, the representation of the boundary circle can be obtained by making full use of morphological dilation and erosion operations. In this way, context information around the target boundary can be explicitly captured. In addition, convolution kernel size ok of the pooling operation is affected by a current learning performance of the network. When an average performance of morphological learning of the target region evaluated by using the DSC is improved to level 8, the adaptive morphological feature fusion module will further reduce a boundary circle to achieve fine learning of the pancreas and the tumor. It should be noted that as shown in Equation 14, the convolution kernel size is set as an odd number. The kernel size will be linearly reduced as a model performance is further improved.

$${L}_{B C} = min \{ - \frac{1}{N} {\sum }_{n = 0}^{N - 1} [ {Y}^{b} ln {y}_{k}^{b} + ( 1 - {Y}^{b} ) ln ( 1 - {y}_{k}^{b} ) ] - \frac{2 {\sum }_{{n}_{b}} {Y}^{b} {y}_{k}^{b}}{{\sum }_{{n}_{b}} ( {Y}^{b} + {y}_{k}^{b} )} , 0 \} \qquad ( 13 )$$

$$[ \begin{matrix}{Y}^{b} \\ {y}_{k}^{b}\end{matrix} ] = \{ \begin{matrix}[ \begin{matrix}Y ⊕ S [ {σ}_{0} ] XOR Y ⊖ S [ {σ}_{0} ] \\ {y}_{k} ⊕ S [ {σ}_{0} ] XOR {y}_{k} ⊖ S [ {σ}_{0} ]\end{matrix} ] , \frac{2 \vert {y}_{k} ⋂ Y \vert}{\vert {y}_{k} \vert + \vert Y \vert} < δ \\ [ \begin{matrix}Y ⊕ S [ {σ}_{0} - 2 ] XOR Y ⊖ S [ {σ}_{0} - 2 ] \\ {y}_{k} ⊕ S [ {σ}_{0} - 2 ] XOR {y}_{k} ⊖ S [ {σ}_{0} - 2 ]\end{matrix} ] , \frac{2 \vert {y}_{k} ⋂ Y \vert}{\vert {y}_{k} \vert + \vert Y \vert} \geq δ\end{matrix} \qquad ( 14 )$$

Specifically, N and n_{b} are a number of samples and a number of voxels of a boundary circle after transformation respectively, and Y^{b} and yₖ^{b} are a reference boundary circle and a predicted boundary circle obtained by the dilation and erosion operations shown in FIG. 4 at a k^{th} epoch. Moreover, Y is an original label, yₖ is a prediction result of the network at the k^{th} epoch, S[⋅] is a binary structuring element for a morphological operation, σ₀ is an initial convolution kernel size of a max pooling operation, and a value of fixed parameter δ∈[0,1] is consistent with a value in Equation 12.

In summary, the AMF2 module fuses the above morphological information under the supervision of loss L_{AMF2}, which can be expressed as follows:

$${L}_{A M F 2} = {L}_{1} + λ {L}_{B C} \qquad ( 15 )$$

Specifically, λ∈[0,1] is a fixed parameter, and can control an effect of context representations of a learning boundary on the network.

To assess validity of the model, according to the present disclosure, an experiment is performed on a MSD pancreas dataset. The MSD pancreas dataset, provided by Memorial Sloan-Kettering Cancer Center, includes three labels, that is, background, pancreas, and tumor. The dataset includes 281 training cases and 139 testing cases, which can be used to simultaneously segment the pancreas and the tumor. Since labels of the testing sets cannot be obtained, an original testing set in the MSD pancreas dataset is not used in the experiment, and only 281 abdominal CT images with pancreas and tumor labels are used. All the CT images are labeled by the radiologist in Scout software, and the image has a size of 512×512×[37, 751]. To further research a generalization capability of the proposed model, the proposed model is applied to the public LiTS benchmark. The dataset includes primary and secondary liver tumor lesions having different sizes and appearances. Data and labels are created by seven hospitals and research institutions collaboratively, and include 131 CT images with liver and tumor labels. The image has a size of 512×512×[54, 551], and a slice spacing ranges from 0.45 mm to 6.0 mm. Due to unclear boundaries, complex structures, and diverse morphological distribution of a liver and a tumor, automatic segmentation of the liver and the tumor is extremely challenging.

Evaluation indexes of the model are a Dice similarity coefficient (DSC), an average surface distance (ASD), a positive predictive value (PPV), and sensitivity (SEN). After five-fold cross-validation, a DSC, an ASSD, a PPV, and SEN of the pancreas obtained by the model are 85.21%, 1.876 mm, 86.25%, and 86.38% respectively, and a DSC, an ASSD, a PPV, and SEN of the tumor are 60.25%, 5.470 mm, 67.97%, and 62.46% respectively. A relatively accurate automatic labeling capability is shown. In addition, a relatively high PPV and relatively high SEN reflect a relatively low mis-segmentation rate of the model on automatic segmentation of the pancreas and the tumor.

As shown in FIG. 7, three examples (Example 1, Example 2, and Example 3) of joint segmentation of a pancreas and a tumor on the MSD dataset are shown. From left to right, original CT images, 3D labels, 3D segmentation results, 3D labels, and 3D segmentation results are shown. Moreover, DSC1 and DSC2 represent segmentation results of the pancreas and the tumor respectively.

To further verify validity and robustness of the network proposed in the present disclosure, liver and tumor regions are segmented simultaneously by using the network from the LiTS benchmark. Five-fold cross-validation results demonstrate that the model in the present disclosure has a favorable generalization capability. An average DSC of the liver and the tumor is 80.28%, DSCs obtained on the liver and tumor regions are 95.73% and 64.83% respectively, PPVs are 94.83% and 70.39% respectively, and SEN is 95.94% and 68.22% respectively.

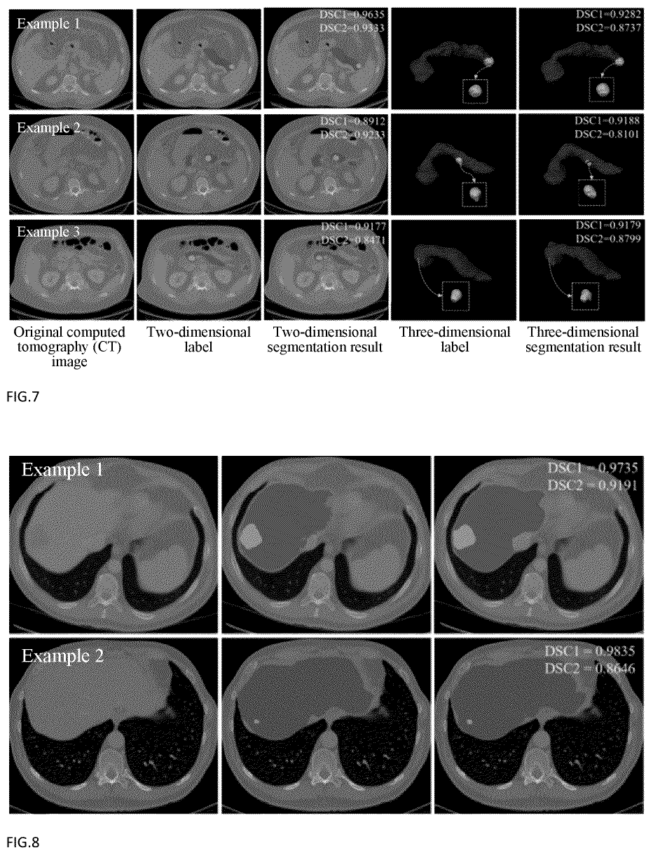

As shown in FIG. 8, two segmentation examples (Example 1 and Example 2) of liver and tumor regions in a LiTS benchmark are shown. From left to right, original CT images, labels, segmentation results of the proposed network are shown. Further, DSC1 and DSC2 represent segmentation results of the liver and tumor regions respectively.

### Example 2

The present example provides a medium. The medium stores a program. When the program is executed by a processor, the following steps are implemented:

A 3D CT image to be segmented is acquired.

The 3D CT image to be segmented is input into a trained multi-view feature fusion network model. A shallow feature of the 3D CT image to be segmented is extracted through a convolution operation. A shallow feature map is obtained. The shallow feature map is split. Positional encoding is added. The shallow feature map is reconstructed into a code sequence. The code sequence is input into a lightweight Transformer. A global dependency relationship of the shallow feature is extracted. A plurality of operations (such as convolution, element-wise addition, union, and element-wise multiplication) is carried out on the shallow feature map. A first feature map is obtained. The global dependency relationship and the first feature map are fused. A second feature map is obtained.

Redundant information is discarded from a feature map obtained through a convolution operation of each layer of a network. A top-level feature map of which redundant information is discarded is regarded as a third feature map.

Pooling operations (morphological dilation and erosion operations) are carried out on the third feature map. A predicted boundary circle of a target region is obtained. A regularization item is added to the predicted boundary circle. A reference boundary circle is obtained. A tumor segmentation result of the 3D CT image to be segmented is output.

Wherein, determining at least one feature of a tumor to the pancreatic cancer detection of the patient to be detected by analyzing the output tumor segmentation result of the 3D CT image to be segmented.

More detailed steps are the same as those in Example 1, and will not be repeated herein.

### Example 3

The present example provides an electronic device. The electronic device includes a memory, a processor, and a program stored in the memory and operable on the processor. When the processor executes the program, the following steps are implemented.

A 3D CT image to be segmented is acquired.

The 3D CT image to be segmented is input into a trained multi-view feature fusion network model. A shallow feature of the 3D CT image to be segmented is extracted through a convolution operation. A shallow feature map is obtained. The shallow feature map is split. Positional encoding is added. The shallow feature map is reconstructed into a code sequence. The code sequence is input into a lightweight Transformer. A global dependency relationship of the shallow feature is extracted. A plurality of operations (such as convolution, element-wise addition, union, and element-wise multiplication) is carried out on the shallow feature map. A first feature map is obtained. The global dependency relationship and the first feature map are fused. A second feature map is obtained.

Redundant information is discarded from a feature map obtained through a convolution operation of each layer of a network. A top-level feature map of which redundant information is discarded is regarded as a third feature map.

Pooling operations (morphological dilation and erosion operations) are carried out on the third feature map. A predicted boundary circle of a target region is obtained. A regularization item is added to the predicted boundary circle. A reference boundary circle is obtained. A tumor segmentation result of the 3D CT image to be segmented is output.

Wherein, determining at least one feature of a tumor to the pancreatic cancer detection of the patient to be detected by analyzing the output tumor segmentation result of the 3D CT image to be segmented.

More detailed steps are the same as those in Example 1, and will not be repeated herein.

Those skilled in the art should understand that various modules or steps of the disclosure mentioned above may be implemented by a general-purpose computer device. Alternatively, the modules or steps may be implemented by program code capable of being executed by a computing device. Thus, the modules or steps may be stored in a memory device to be executed by the computing device, may be fabricated as individual integrated circuit modules separately, or may be implemented by fabricating a plurality of the modules or steps as a single integrated circuit module. The disclosure is not limited to any specific combination of hardware and software. The above examples are merely preferred embodiments of the present disclosure, and are not intended to limit the present disclosure. Those skilled in the art can make various modifications and changes on the present disclosure. Any modifications, equivalent substitutions, improvements, etc. within the spirit and principles of the present disclosure should fall within the scope of protection of the present disclosure.

Particular implementations of the present disclosure are described above in combination with the accompanying drawings, but are not intended to limit the scope of protection of the present disclosure. Those skilled in the art should understand that based on the technical solutions of the present disclosure, various modifications or variations that can be made by those skilled in the art without creative labor still fall within the scope of protection of the present disclosure.

1. A system for pancreatic cancer image segmentation based on a multi-view feature fusion network, the system comprising:
a computed tomography (CT) device configured to acquire a CT image of a specific region of an abdomen of a patient to be detected for pancreatic cancer, acquire a three-dimensional (3D) CT image to be segmented, and input the 3D CT image to be segmented into a computer; and
the computer is configured to:
input the 3D CT image to be segmented into a trained multi-view feature fusion network model, extract a shallow feature of the 3D CT image to be segmented through a convolution operation, obtain a shallow feature map, split the shallow feature map, add positional encoding, reconstruct the shallow feature map into a code sequence, input the code sequence into a lightweight Transformer, and extract a global dependency relationship of the shallow feature; and, carry out a plurality of operations on the shallow feature map, obtain a first feature map, fuse the global dependency relationship and the first feature map, and obtain a second feature map;
discard redundant information from a feature map obtained through a convolution operation of each layer of the network, and regard a top-level feature map of which redundant information is discarded as a third feature map;
carry out pooling operations (morphological dilation and erosion operations) on the third feature map, obtain a predicted boundary circle of a target region, add a regularization item to the predicted boundary circle, and obtain a reference boundary circle; and
output a tumor segmentation result of the 3D CT image to be segmented, wherein
determining at least one feature of a tumor to the pancreatic cancer detection of the patient to be detected by analyzing the output tumor segmentation result of the 3D CT image to be segmented.

2. The system for pancreatic cancer image segmentation based on a multi-view feature fusion network according to claim 1, wherein the redundant information is discarded from the feature map obtained through the convolution operation of each layer of the network specifically as follows:
a feature is extracted by a Gram matrix from the feature map obtained through the convolution operation of each layer of the network, a corresponding attention feature map is generated, and the feature map obtained through the convolution operation of each layer is connected to the corresponding attention feature map.

3. The system for pancreatic cancer image segmentation based on a multi-view feature fusion network according to claim 2, wherein the redundant information is generated by inversely quantizing mutual information between an input feature map and a generated attention feature map.

4. The system for pancreatic cancer image segmentation based on a multi-view feature fusion network according to claim 1, wherein a convolution kernel size of the pooling operation is affected by a learning performance of the network, and when an average performance of morphological learning of the target region evaluated by using a Dice similarity coefficient is improved to a set level, the adaptive morphological feature fusion module reduces a boundary circle.

5. The system for pancreatic cancer image segmentation based on a multi-view feature fusion network according to claim 4, wherein the convolution kernel size of the pooling operation is an odd number, and the kernel size is linearly reduced as a model performance is improved.

6. The system for pancreatic cancer image segmentation based on a multi-view feature fusion network according to claim 1, wherein the regularization item is added to the predicted boundary circle, and the reference boundary circle is obtained specifically as follows:
a representation of a boundary circle is obtained through the morphological dilation and erosion operations, and context information around a target boundary is captured.

7. The system for pancreatic cancer image segmentation based on a multi-view feature fusion network according to claim 1, wherein validity of the multi-view feature fusion network is validated through five-fold cross-validation; and
evaluation indexes are a Dice similarity coefficient, an average surface distance, a positive predictive value, and sensitivity.

8. The system for pancreatic cancer image segmentation based on a multi-view feature fusion network according to claim 1, wherein the computer preprocesses the 3D CT image specifically as follows:
rotation, scaling, elastic deformation, gamma correction, mirroring, and brightness adjustment operations are carried out on the 3D CT image, the 3D CT image is clipped into an image having a fixed size, and the image is manually labeled.

9. A non-transitory computer-readable medium, storing a program, wherein when the program is executed by a processor, the following steps are implemented:
acquiring a 3D CT image to be segmented;
inputting the 3D CT image to be segmented into a trained multi-view feature fusion network model, extracting a shallow feature of the 3D CT image to be segmented through a convolution operation, obtaining a shallow feature map, splitting the shallow feature map, adding positional encoding, reconstructing the shallow feature map into a code sequence, inputting the code sequence into a lightweight Transformer, and extracting a global dependency relationship of the shallow feature; and carrying out a plurality of operations on the shallow feature map, obtaining a first feature map, fusing the global dependency relationship and the first feature map, and obtaining a second feature map;
discarding redundant information from a feature map obtained through a convolution operation of each layer of a network, and regarding a top-level feature map of which redundant information is discarded as a third feature map; and
carrying out pooling operations (morphological dilation and erosion operations) on the third feature map, obtaining a predicted boundary circle of a target region, adding a regularization item to the predicted boundary circle, obtaining a reference boundary circle, and outputting a tumor segmentation result of the 3D CT image to be segmented, wherein
determining at least one feature of a tumor to the pancreatic cancer detection of the patient to be detected by analyzing the output tumor segmentation result of the 3D CT image to be segmented.

10. An electronic device, comprising a memory, a processor, and a program stored in the memory and operable on the processor, wherein when the processor executes the program, the following steps are implemented:
acquiring a 3D CT image to be segmented;
inputting the 3D CT image to be segmented into a trained multi-view feature fusion network model, extracting a shallow feature of the 3D CT image to be segmented through a convolution operation, obtaining a shallow feature map, splitting the shallow feature map, adding positional encoding, reconstructing the shallow feature map into a code sequence, inputting the code sequence into a lightweight Transformer, and extracting a global dependency relationship of the shallow feature; and carrying out a plurality of operations on the shallow feature map, obtaining a first feature map, fusing the global dependency relationship and the first feature map, and obtaining a second feature map;
discarding redundant information from a feature map obtained through a convolution operation of each layer of a network, and regarding a top-level feature map of which redundant information is discarded as a third feature map; and
carrying out pooling operations (morphological dilation and erosion operations) on the third feature map, obtaining a predicted boundary circle of a target region, adding a regularization item to the predicted boundary circle, obtaining a reference boundary circle, and outputting a tumor segmentation result of the 3D CT image to be segmented, wherein
determining at least one feature of a tumor to the pancreatic cancer detection of the patient to be detected by analyzing the output tumor segmentation result of the 3D CT image to be segmented.

11. The system for pancreatic cancer image segmentation based on a multi-view feature fusion network according to claim 1, wherein the at least one feature of the tumor comprises but is not limited to a tumor region, a tumor size, and a tumor and tissue boundary position.
